(19) United States
(12) Patent Application Publication
(10) Pub. No.: US 2026/0181515 A1
(43) Pub. Date: Jun. 25, 2026

(54) METHOD AND APPARATUS FOR SUPPORTING SELF-CONFIGURATION AND SELF-OPTIMIZATION

(71) Applicant: SAMSUNG ELECTRONICS CO., LTD., Suwon-si, Gyeonggi-do (KR)

(72) Inventors: Lixiang XU, Beijing (CN); Weiwei WANG, Beijing (CN); Hong WANG, Beijing (CN)

(21) Appl. No.: 18/998,460

(22) PCT Filed: Jul. 27, 2023
(86) PCT No.: PCT/KR2023/010879

§ 371 Date: Jan. 24, 2025

(30) Foreign Application Priority Data
Jul. 27, 2022 (CN) 202210891882.X
Apr. 6, 2023 (CN) 202310364343.5

(51) Int. Cl. H04W 36/36; H04W 56/00; H04W 76/20

(52) U.S. Cl. CPC H04W 36/362; H04W 56/0015; H04W 76/20

(57) ABSTRACT

The disclosure relates to a 5G or 6G communication system for supporting a higher data transmission rate. A method performed by a user equipment (UE) in a wireless communication system is provided. The method comprises receiving, from a secondary node (SN), an SN radio resource control (RRC) message including a first conditional primary secondary cell group cell change (CPC) configuration for an intra-SN CPC, receiving, from a master node (MN), an MN RRC message including a second CPC configuration for an inter-SN CPC, in case that a candidate primary secondary cell group cell (PSCell) satisfies a corresponding CPC execution condition of the first CPC configuration, performing a synchronization to the candidate PSCell; removing the second CPC configuration and transmitting an RRC reconfiguration complete message on the candidate PSCell.

### TECHNICAL FIELD

The disclosure relates to wireless communication technology, in particular to a method and apparatus for supporting self-configuration and self-optimization.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

According to an embodiment, a method performed by a user equipment (UE) in a wireless communication system is provided. The method comprises receiving, from a secondary node (SN), an SN radio resource control (RRC) message including a first conditional primary secondary cell group cell change (CPC) configuration for an intra-SN CPC, receiving, from a master node (MN), an MN RRC message including a second CPC configuration for an inter-SN CPC, in case that a candidate primary secondary cell group cell (PSCell) satisfies a corresponding CPC execution condition of the first CPC configuration, performing a synchronization to the candidate PSCell, removing the second CPC configuration and transmitting an RRC reconfiguration complete message on the candidate PSCell.

According to an embodiment, a user equipment (UE) in a wireless communication system is provided. The UE comprises a transceiver and a controller coupled with the transceiver and configured to receive, from a secondary node (SN), an SN radio resource control (RRC) message including a first conditional primary secondary cell group cell change (CPC) configuration for an intra-SN CPC, receive, from a master node (MN), an MN RRC message including a second CPC configuration for an inter-SN CPC, in case that a candidate primary secondary cell group cell (PSCell) satisfies a corresponding CPC execution condition of the first CPC configuration, perform a synchronization to the candidate PSCell, remove the second CPC configuration and transmit an RRC reconfiguration complete message on the candidate PSCell.

According to an embodiment, a method performed by a secondary node (SN) in a wireless communication system is provided. The method comprises transmitting, to a user equipment (UE), an SN radio resource control (RRC) message including a first conditional primary secondary cell group cell change (CPC) configuration for an intra-SN CPC and in case that a candidate primary secondary cell group cell (PSCell) satisfies a corresponding CPC execution condition of the first CPC configuration, receiving, from the UE, an RRC reconfiguration complete message on the candidate PSCell. The candidate PSCell is based on the first CPC configuration for the intra-SN CPC and is not based on a second CPC configuration for an inter-SN CPC.

According to an embodiment, a secondary node (SN) in a wireless communication system is provided. The SN comprises a transceiver and a controller coupled with the transceiver and configured to transmit, to a user equipment (UE), an SN radio resource control (RRC) message including a first conditional primary secondary cell group cell change (CPC) configuration for an intra-SN CPC and in case that a candidate primary secondary cell group cell (PSCell) satisfies a corresponding CPC execution condition of the first CPC configuration, receive, from the UE, an RRC reconfiguration complete message on the candidate PSCell. The candidate PSCell is based on the first CPC configuration for the intra-SN CPC and is not based on a second CPC configuration for an inter-SN CPC.

### BRIEF DESCRIPTION OF DRAWINGS

The above and other aspects, features, and advantages of the present disclosure will be more apparent from the following detailed description when taken in conjunction with the accompanying drawings, in which:

FIG. 1 is a system architecture diagram of System Architecture Evolution (SAE);

FIG. 2 is a schematic diagram illustrating an initial overall architecture of 5G;

FIG. 3 is a flowchart of a first method according to an embodiment of the present disclosure;

FIG. 4 is a schematic diagram of the first method according to an embodiment of the present disclosure;

FIG. 5 is a schematic diagram of a second method according to an embodiment of the present disclosure;

FIG. 6 is a schematic diagram of a third method according to an embodiment of the present disclosure;

FIG. 7 is a schematic diagram of a fourth method according to an embodiment of the present disclosure;

FIG. 8 is a schematic diagram of a fifth method according to an embodiment of the present disclosure;

FIG. 9 is a block diagram of a network device according to an embodiment of the present disclosure;

FIG. 10 illustrates a structure of a UE according to an embodiment of the disclosure; and

FIG. 11 illustrates a structure of a base station according to an embodiment of the disclosure.

### BEST MODE FOR CARRYING OUT THE INVENTION

In order to make the purpose, technical schemes and advantages of the embodiments of the disclosure clearer, the technical schemes of the embodiments of the disclosure will be described clearly and completely with reference to the drawings of the embodiments of the disclosure. Apparently, the described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain terms and phrases used throughout the present patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in an appropriate computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the present disclosure. For example, unless otherwise defined, the technical terms or scientific terms used in the disclosure shall have the ordinary meaning understood by those with ordinary skills in the art to which the present disclosure belongs.

It should be understood that “first”, “second” and similar terms used in the disclosure do not express any order, quantity or importance, but are only used to distinguish different components. Similar terms such as singular forms “a”, “an” or “the” do not express a limitation of quantity, but express the existence of at least one of the referenced item, unless the context clearly dictates otherwise.

As used herein, any reference to “an example” or “example”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

It will be further understood that similar terms such as “include” or “comprise” mean that elements or objects appearing before the term encompass the listed elements or objects appearing after the term and their equivalents, but other elements or objects are not excluded. Similar terms such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies. In addition, the technical schemes of the embodiments of the present application can be applied to future-oriented communication technologies.

The following description with reference to the accompanying drawings is provided to assist in a comprehensive understanding of various embodiments of the present disclosure as defined by the claims and their equivalents. The following description includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and phrases used in the following description and claims are not limited to the bibliographical meanings, but, are merely used by the inventor(s) to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed functions, operations or components which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude a possibility of the existence of one or more other characteristics, numbers, steps, operations, constituent elements, components or combinations thereof.

The term “or” used in various embodiments of the present disclosure includes any or all of combinations of listed items. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

For an enhanced mobility scheme, how to support mobility robustness in the process of a dual connectivity is a problem that needs to be solved at present.

The application provides a method and device for supporting self-configuration and self-optimization. The method, which is performed by a first network node of a communication system, includes: receiving information related to a Secondary Cell Group (SCG) failure of SCG from a User Equipment (UE); transmitting a first failure report information to a second network node.

According to an aspect of the present disclosure, there is provided a method performed by a first network node of a communication system, the method including: receiving information related to Secondary Cell Group (SCG) failure of a secondary cell group from a User Equipment (UE); transmitting first failure report information to a second network node.

According to an embodiment of the present disclosure, the method further comprises: transmitting second failure report information to a third network node; receiving third failure report information from the third network node, wherein the third failure report information is in response to the second failure report information transmitted to the third network node; wherein the first failure report information transmitted to the second network node is transmitted based on the third failure report information.

According to an embodiment of the present disclosure, the second network node is a network node that leads to the SCG failure.

According to an embodiment of the present disclosure, the method further comprises: deciding the network node that leads to the failure and/or a type of the failure based on the information related to the SCG failure.

According to an embodiment of the present disclosure, the first failure report information or the second failure report information includes at least one of the following: a cell identity of a source Primary SCG Cell (PSCell), a cell identity of a target PSCell, a cell identity of a failed PSCell, a cell identity of a suitable PSCell, information related to the SCG failure received from the UE, a list of candidate PSCells recommended by a master network node or a source secondary network node, Conditional PSCell Change (CPC) execution condition(s), a list of candidate PSCells selected by a target network node or a candidate target network node, an estimated arrival probability, a type of the failure, a cell identity of a suitable PSCell that is not selected by the target network node or the candidate target network node, and indication information that the selected candidate PSCell is unsuitable.

According to an embodiment of the present disclosure, the third failure report information includes at least one of the following: a master network node UE access protocol identification MN UE AP ID, a secondary network node UE access protocol identification SN UE AP ID, a list of candidate primary SCG cells (PSCells) recommended by a source secondary network node, a list of candidate PSCells selected by a target secondary network node or a candidate target network node, a cell identity of a suitable PSCell, information related to the SCG failure, a cell identity of a source PSCell, a cell identity of a target PSCell, a cell identity of a suitable PSCell which is not selected by the target network node or the candidate target network node, and indication information that the selected candidate PSCell is not suitable.

According to an embodiment of the present disclosure, the method further includes receiving Modification Required information of the second network node from the second network node, wherein the Modification Required information includes at least one of the following: a list of candidate Primary SCG Cells (PSCell), Conditional PSCell Change (CPC) execution condition(s), and a maximum number of PSCells.

According to an embodiment of the present disclosure, the method further includes receiving, from the second network node, information regarding that a cell change procedure is triggered by the second network node, wherein the information regarding that the cell change procedure is triggered by the second network node includes at least one of the following: information that the second network no has triggered a Conditional PSCell Change (CPC) procedure, a list of candidate primary SCG cells (PSCells), and CPC execution condition(s).

According to an embodiment of the present disclosure, the information related to the SCG failure includes at least one of the following: indication information that whether a Conditional PSCell Change (CPC) has been executed; a time from a CPC execution to a failure; a cell identity of a failed Primary SCG Cell (PSCell); a cell identity of a source PSCell of the latest PSCell change; a cell list of CPC candidate PSCells; CPC execution condition(s); a time from UE receiving CPC configuration to the failure; a time from UE receiving the CPC configuration to the CPC execution; when a CPC execution condition is fulfilled for the execution, indication information corresponding to the CPC execution condition being fulfilled for the execution, information that which CPC execution condition is fulfilled first, a time between two CPC execution conditions being fulfilled, indication information on the CPC or a conditional primary SCG cell addition (CPA), information on SCG status, and information on Master Cell Group (MCG) status.

According to another aspect of the present disclosure, there is provided a method performed by a second network node of a communication system, the method including: transmitting a RRC reconfiguration message including Conditional Primary SCG Cell Change (CPC) configuration to a User Equipment (UE); receiving a first failure report information from a first network node.

According to an embodiment of the present disclosure, the received first failure report information is transmitted by the first network node based on the third failure report information, wherein the third failure report information is transmitted by the third network node in response to the second failure report information transmitted by the first network node to the third network node.

According to an embodiment of the present disclosure, the first failure report information or the second failure report information includes at least one of the following: a cell identity of a source Primary SCG Cell (PSCell), a cell identity of a target PSCell, a cell identity of a failed PSCell, a cell identity of a suitable PSCell, information related to the SCG failure received from a UE, a list of candidate PSCells recommended by a master network node or a source secondary network node, Conditional PSCell Change (CPC) execution condition(s), a list of candidate PSCells selected by a target network node or a candidate target network node, an estimated arrival probability, a type of failure, a cell identity of a suitable PSCell that is not selected by the target network node or the candidate target network node, and indication information that the selected candidate PSCell is unsuitable.

According to an embodiment of the present disclosure, the third failure report information includes at least one of the following: a master network node UE access protocol identity MN UE AP ID, a secondary network node UE access protocol identity SN UE AP ID, a list of candidate primary SCG cells (PSCells) recommended by a source secondary network node, a list of candidate PSCells selected by a target secondary network node or a candidate target network node, a cell identity of a suitable PSCell, information related to SCG failure, a cell identity of a source PSCell, a cell identity of a target PSCell, a cell identity of a suitable PSCell which is not selected by the target network node or the candidate target network node, and indication information that the selected candidate PSCell is not suitable.

According to an embodiment of the present disclosure, the method further comprises: transmitting Modification Required information of the second network node to the first network node, wherein the Modification Required information comprises at least one of the following: a list of candidate Primary SCG Cells (PSCells), Conditional Primary SCG Cells Change (CPC) execution condition(s), and a maximum number of PSCells.

According to an embodiment of the present disclosure, the method further comprises transmitting, to the first network node, information regarding that the second network node triggered a cell change procedure, wherein the information regarding that the second network node triggered the cell change procedure includes at least one of the following: information that a secondary network node triggered a Conditional Primary SCG cell Change (CPC) procedure, a list of candidate primary SCG cells (PSCells), and CPC execution condition(s).

According to another aspect of the present disclosure, there is provided a method performed by a first network node of a communication system, the method including: transmitting an RRC reconfiguration message including Conditional PSCell Change (CPC) configuration configured by the first network node to a User Equipment (UE); receiving, from the second network node, information on CPC execution complete configured by the second network node.

According to an embodiment of the present disclosure, the information on CPC execution complete configured by the second network node includes at least one of the following: a UE identity, a PScell identity, and indication information on CPC cancellation.

According to an embodiment of the present disclosure, indication information regarding that the first network node has configured the CPC by is received by the second network node from the UE.

According to another aspect of the present disclosure, there is provided a method performed by a second network node of a communication system, the method including: transmitting an RRC reconfiguration message including Conditional PSCell Change (CPC) configuration configured by the second network node to a User Equipment (UE); transmitting information on CPC execution complete configured by the second network node to the first network node.

According to an embodiment of the present disclosure, the information on CPC execution complete configured by the second network node includes at least one of the following: a UE identity, a PScell identity, and indication information on CPC cancellation.

According to an embodiment of the present disclosure, the method further includes receiving indication information regarding that the first network node has configured the CPC from the UE.

According to another aspect of the present disclosure, there is provided a network node in a communication system, the network node including a transceiver configured to transmit and receive signals; and a controller coupled to the transceiver and configured to perform operations in the methods as described in the present disclosure.

The above-mentioned method supporting self-configuration and self-optimization can support robustness of a Primary SCG Cell (PSCell) handover in the enhanced mobility procedure. Furthermore, through the above-mentioned method supporting self-configuration and self-optimization, it can be ensured that a cause of a failure are correctly identified, so as to make reasonable optimization, reduce occurrence of the failure, ensure service continuity and reduce labor cost of operators.

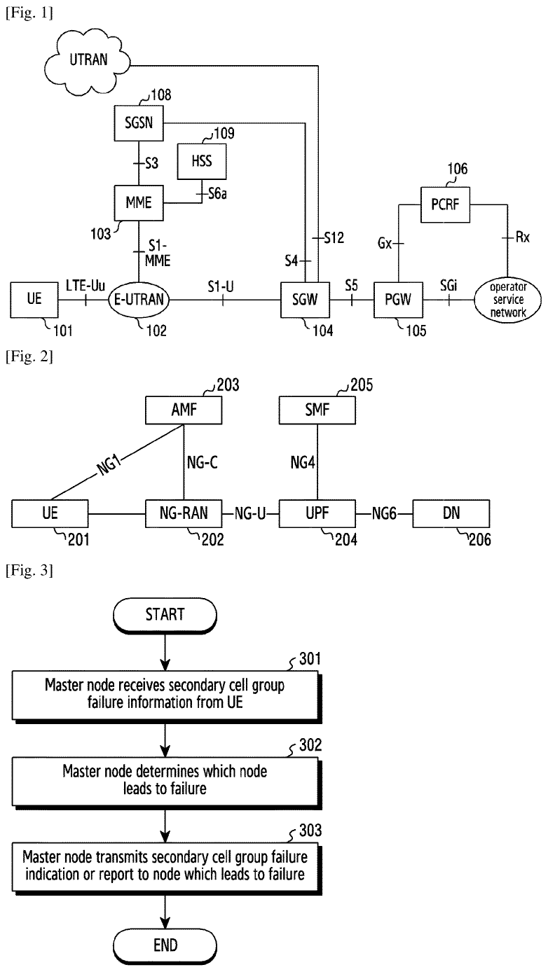

FIGS. 1 to 11 discussed below and various embodiments for describing the principles of the present disclosure in the present patent document are only for illustration and should not be interpreted as limiting the scope of the disclosure in any way. Those skilled in the art will understand that the principles of the present disclosure can be implemented in any suitably arranged system or device.

FIG. 1 illustrates an exemplary system architecture 100 of system architecture evolution (SAE).

Referring to FIG. 1, user equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

FIG. 2 illustrates an exemplary system architecture 200 according to various embodiments of the present disclosure. Other embodiments of the system architecture 200 can be used without departing from the scope of the present disclosure.

Referring to FIG. 2, user equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also referred to as ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

In order to improve the reliability of change of a primary SCG cell (PSCell, SpCell (a primary cell of a master or secondary cell group) of a secondary cell group), a Conditional PSCell Change (CPC) is defined in the current technology. The CPC is internal to a Secondary Node (SN). Furthermore, in the current technology, a Conditional PSCell Addition (CPA) and an inter-SN CPC procedure are further defined. An unreasonable configuration or trigger of the CPA or CPC procedure will also lead to a Secondary Cell Group (SCG) failure. How to identify a type of the failure for a reasonable optimization is a problem that needs to be solved at present.

According to an embodiment of the present disclosure, a SCG Failure Information Report may include a list of recommended candidate Primary SCG Cells (PSCells), CPC execution condition(s), a list of selected candidate PSCells, a type of a CPC failure, and/or an estimated Arrival Probability.

According to an embodiment of the present disclosure, a secondary node (SN) Modification Required may include the CPC execution condition(s).

According to an embodiment of the present disclosure, the SN informs a Master Node (MN) of indication information that the SN triggered the CPC procedure, and the SN may further inform the MN of a list of candidate PSCells configured by the SN and the CPC execution condition(s).

According to an embodiment of the present disclosure, a SCG Failure Transfer transmitted from the SN to the MN may include a list of candidate PSCells recommended by a source SN (S-SN), a list of candidate PSCells selected by a Target SN (T-SN) or candidate target SN, a cell identity of a suitable PSCell, SCG failure information, a cell identity of a source PSCell, a cell identity of a target PSCell, a cell identity of a suitable PSCell that is not selected by the target SN or the candidate target SN, and/or indication information that the selected candidate PSCell is unsuitable.

According to an embodiment of the present disclosure, information which can be contained in the SCG Failure information is illustrated at steps 301, 409, 607, 706 and 809.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

It should be noted that CPC is taken as an example in the present disclosure, and the problems and methods described in the present disclosure are also applicable to a CPA procedure. When applying to the CPA, it is only necessary to replace the CPC with the CPA. Similarly, the problems and methods described in the present disclosure are also applicable to a Conditional PSCell Addition or Change (CPAC) procedure, and the CPC is replaced by the CPAC when applying.

In addition, in the present disclosure, the term “list” is used to represent a form of information, but the present disclosure is not limited to the list of information, and the list of information in the present disclosure can also be represented in various other forms. For example, a list of cells may represent information on one or more cells, but it is not limited to a form of a list.

FIG. 3 illustrates an example of a first method for self-configuration and self-optimization supported in the present disclosure. The method is described from a perspective of a master base station. The method comprises the following steps:

Referring to FIG. 3, at step 301, a master node receives SCG failure information from a UE.

The SCG failure information includes one or more of the following information elements:
Indication information whether a CPC or CPA has been executed;
A time from CPC or CPA execution to a CPC or CPA failure;
A cell identity of a failed PSCell. The cell identity may be information on a global cell identity, or a physical cell identity and a frequency. The global cell identity may further include Tracking Area Code (TAC) or a tracking area identity of the cell; and for a failure during a PSCell change procedure, the cell identity of the failed PSCell is a cell identity of a target PSCell.
A cell identity of a source PSCell of the latest PSCell change. The cell identity may be information on a global cell identity, or a physical cell identity and a frequency. It can also include the Tracking Area Code (TAC) or the tracking area identity of the cell;
A cell list of CPC or CPA candidate PSCells. A list of candidate CPC or CPA cells may be included directly, or indication information that a cell is CPC or CPA candidate cell is included for the cells in a measurement result which are the CPC or CPA candidate cell, additionally, information on one or more CPC or CPA cells which are the CPC or CPA candidate cells but not in the measurement result is comprised in the secondary cell group failure information. Each of the candidate PSCells contains a cell identity, which may be a global cell identity. The cell identity may further include Tracking Area Code (TAC);
CPC or CPA execution condition(s). The CPC or CPA execution condition(s) can be one or more. There are one or more execution conditions for each of candidate PSCell cells;
A Time from UE receiving CPC or CPA configuration to a failure;
A Time from UE receiving the CPC or CPA configuration to CPC or CPA execution;
Indication information corresponding to a CPC or CPA execution condition being fulfilled for execution when the CPC or CPA execution condition is fulfilled for execution;
Information which CPC or CPA execution condition is fulfilled first;
A time between two CPC or CPA execution conditions being fulfilled, for example, the time can be a time duration between the two CPC or CPA execution conditions being fulfilled;
Indication information on CPC or CPA, which indicates that the CPC or CPA is configured;
Status of a SCG, e.g., whether the SCG is activated or deactivated, or the SCG is suspended;
Status of a Master Cell Group (MCG), e.g., whether the MCG is activated or deactivated, or the MCG is suspended.

The above failure can be the SCG failure, but the present disclosure is not limited to this, and it can also be other types of failures occurred in the secondary cell.

At step 302, the master node determines which node leads to the failure. For example, it is the master node, the source secondary node, the target secondary node or other candidate secondary node. In addition, the master node can directly forward the SCG failure information to the secondary node where the failure occurs.

The master node determines which node leads to the failure according to information in the SCG failure information received from the UE and/or the information stored by the MN.

The master node can also decide a type of failure occurred, such as a too early PSCell change, a too late PSCell change or trigger of a PSCell change to a wrong PSCell.

If a SCG failure occurs after a UE has stayed in a PSCell for a long time, for [104] example, in case that the UE does not report the time from CPC execution to failure occurrence, or the time from the CPC execution to the failure occurrence reported by the UE is larger than a configured threshold, and there is a suitable PSCell different from the PSCell where the UE is located at the time of the failure occurrence, it is the too late CPC execution. The MN knows the suitable PSCell according to a measurement report received from the UE, or the MN knows the suitable PSCell according to the measurement report received from the UE and information stored by the MN.

Too early PSCell change: there is a recent CPC execution or PSCell change before the failure occurs, for example, according to an indication on CPC execution or according to a time from the CPC execution to the failure occurrence being smaller than a configured threshold, and the source PSCell is a suitable PSCell, then it is a too early PSCell change. The MN or the source node which triggered the PSCell change knows the suitable PSCell according to a measurement report received from the UE, or the MN or the source node which triggered the PSCell change knows the suitable PSCell according to the measurement report received from the UE and information stored by the MN or the source node which triggered the PSCell change. The SCG failure can a failure which occurs shortly after a successful change from a source PSCell to a target PSCell or occurs during the PSCell change procedure. The source PSCell is a source PSCell of the most recent PSCell change.

Too early CPA execution: the CPA execution failed or the SCG failure occurred shortly after a successful CPA execution, and there is no suitable PSCell according to the measurement report received from the UE, or it is aware of that there is no suitable PSCell according to the measurement report received from the UE and the information stored by the node. For example, according to an indication on the CPA execution or according to a time from the CPA execution to the CPA failure being smaller than a configured threshold and there is no suitable PSCell, it is the too early CPA execution. The MN knows that there is no suitable PSCell according to the measurement report received from the UE, or the MN knows that there is no suitable PSCell according to the measurement report received from the UE and the information stored by the MN.

Trigger of a PSCell change to a wrong PSCell: before the failure occurs, there is a recent CPC execution or PSCell change, for example, according to an indication on CPC execution or according to a time from the CPC execution to the failure occurrence being smaller than a configured threshold, and the suitable PSCell is not the source PSCell or the target PSCell, it is trigger of the PSCell change to the wrong PSCell. The MN knows the suitable PSCell according to a measurement report received from the UE, or the MN knows the suitable PSCell according to the measurement report received from the UE and information stored by the MN. The SCG failure can a failure which occurs shortly after a successful change from a source PSCell to a target PSCell or occurs during the PSCell change procedure. The source PSCell is a source PSCell of the most recent PSCell change. The target PSCell is a target PSCell of the most recent PSCell change.

For the too late PSCell change, the MN and the source SN are the nodes that lead to the failure.

For the too early PSCell change, in case that the PSCell change is triggered by the MN, then the MN is the node that leads to the failure. In case that the PSCell change is triggered by the source SN, the source SN is the node that leads to the failure. For the too early CPA execution, the MN is the node which leads to the failure.

For the trigger of the PSCell change to the wrong PSCell, in case that the PSCell change is triggered by the MN, then the MN is the node that leads to the failure. In case that the PSCell change is triggered by the source SN, the source SN is the node that leads to the failure.

For the trigger of the PSCell change to the wrong PSCell, the MN can further decide whether the failure is caused by the unreasonable configuration of CPC candidate cells or by the unreasonable configuration of CPC execution condition. If the suitable cell is not in the CPC candidate cells configured to the UE, the failure is caused by the unreasonable configuration of CPC candidate cells. If the suitable cell is not in the list of the CPC candidate cells recommended by a source base station (the MN or a source SN) that triggers the PSCell change, the problem is caused by the source base station that triggers the PSCell change. For example, if the PSCell change is triggered by the MN, it is a problem caused by the MN, and if the PSCell change is triggered by the source SN, the problem is caused by the source SN. If the suitable cell is in the list of the CPC candidate cells recommended by the source base station (the MN or the source SN) that triggers the PSCell change, but not in the list of the candidate PSCells selected by the target SN or the candidate target SN, the failure is caused by the target SN or the candidate target SN.

The MN or the source SN can also decide whether the failure is caused by an estimated arrival possibility which is set improperly. For example, the estimated arrival probability transmitted to the candidate target SN by the MN or by the source SN through the MN is set too low, resulting in that the target SN or the candidate SN fails to select the candidate cell as the selected candidate cell or fails to allocate appropriate resources to the candidate cell in time, while the suitable cell is in the candidate SNs, and thus the MN or the source SN is the node that leads to the failure. If the estimated arrival probability is determined by the source SN, the failure is led to by the source SN.

The MN or the source SN can also decide whether the failure is caused by the improper setting of the maximum number of the prepared PSCells. For example, the maximum number of the prepared PSCells sent by the MN or the source SN via the MN to the candidate target SN is too low, resulting in that the target SN or the candidate SN does not select the suitable cell as the selected candidate cell, but the suitable cell is in the candidate SN. In this case, the MN or the source SN is the node that leads to the failure. In case that the maximum number of the prepared PSCells is determined by the source SN, the failure is caused by the source SN.

The CPC is taken as an example for the above description of triggering of the PSCell change to the wrong PSCell, and such a description is also applicable to the CPA procedure.

In case that the MN is the node which leads to the failure, step 303 does not need to be performed. If the problem is caused by the source SN, the target SN or the candidate target SN, step 303 is performed.

At step 303, the master node transmits an indication or report of the SCG failure to a node which leads to the failure. The node which leads to the failure can be the source SN, the target SN or the candidate SN.

According to the description regarding the step 302, the MN knows that the failure is caused by the source SN, the target SN or the candidate target SN.

The MN can transmit information on the SCG failure to the node which leads to the failure through the SCG failure information report message or other messages.

The message transmitted by the master node to the node which leads to the failure includes one or more of the following information elements:
A cell identity of the source PSCell;
A cell identity of the target PSCell or a cell identity of the failed PSCell;
A cell identity of the suitable PSCell;
SCG failure information received from the UE;
A list of candidate PSCells recommended by the MN or the source SN; each of candidate PSCells includes a cell identity, which may be a global cell identity, and the global cell identity may further include a tracking area code (TAC);
CPC execution condition(s), there are one or more execution conditions for each of candidate PSCells;
A list of candidate PSCells selected by the target SN or the candidate target SN; each of candidate PSCells includes a cell identity, which may be a global cell identity, and the global cell identity may further include a Tracking Area Code (TAC). The message may include a list of candidate PSCells selected by the target SN or the candidate target SN. Alternatively, by means of including indication information on whether a PSCell is selected by the target SN or the candidate target SN in a list of candidate PSCells recommended by the MN or the source SN, the target SN or the candidate target SN knows which in the list of candidate PSCells recommended by the MN or the source SN are candidate PSCells selected by the target SN or the candidate target SN and which are candidate PSCells not selected by the target SN or the candidate target SN, according to the indication information in the list of candidate PSCells recommended by the MN or the source SN;
A list of the PSCells which are not accepted by the target SN or the candidate target SN, in the list of candidate PSCells recommended by the MN or the source SN;
The maximum number of the prepared PSCells;
An estimated Arrival Probability;
A type of the failure, which includes a too early PSCell change, a too late PSCell change or trigger of a PSCell change to a wrong PSCell, an inappropriate configuration for the CPC candidate cell, an inappropriate CPC execution condition, an inappropriate maximum number of the prepared PSCells, and/or an inappropriate configuration for the estimated arrival probability. This information element is included in case that the type of the failure is decided by the MN, and this information element is not included in case that the type of failure is decided by the SN which leads to problems.

In case that the MN only decides which node leads to the failure, the source SN, the target SN or the candidate SN will decide the type of failure after receiving the message from the MN, such as, e.g., a too early PSCell change, a too late PSCell change or trigger of a PSCell change to a wrong PSCell.

In case that a SCG failure occurs after a UE has stayed in a PSCell for a long time, for example, in case that the UE does not report the time from CPC execution to failure occurrence, or the time from the CPC execution to the failure occurrence reported by the UE is larger than a configured threshold, and there is a suitable PSCell different from the PSCell where the UE is located at the time of the failure occurrence, it is the too late CPC execution. The SN knows the suitable PSCell according to a measurement report received from the UE, or the SN knows the suitable PSCell according to the measurement report received from the UE and information stored by the SN. The measurement report received from the UE is received through the SCG failure information received by the MN from the UE.

Too early PSCell change: there is the recent CPC execution or PSCell change before the failure occurs, for example, according to an indication on CPC execution or according to a time from the CPC execution to the failure occurrence being smaller than a configured threshold, and the source PSCell is a suitable PSCell, then it is a too early PSCell change. The SN knows the suitable PSCell according to a measurement report received from the UE, or the SN knows the suitable PSCell according to the measurement report received from the UE and information stored by the SN. The SCG failure can a failure which occurs shortly after a successful change from a source PSCell to a target PSCell or occurs during the PSCell change procedure. The source PSCell is a source PSCell of the most recent PSCell change. The measurement report received from the UE is received through the SCG failure information received by the MN from the UE.

Trigger of a PSCell change to a wrong PSCell: before the failure occurs, there is the recent CPC execution or PSCell change, for example, according to an indication on CPC execution or according to a time from the CPC execution to the failure occurrence being smaller than a configured threshold, and the suitable PSCell is not the source PSCell or the target PSCell, it is trigger of the PSCell change to the wrong PSCell. The SN knows the suitable PSCell according to a measurement report received from the UE, or the SN knows the suitable PSCell according to the measurement report received from the UE and information stored by the SN. The SCG failure can a failure which occurs shortly after a successful change from a source PSCell to a target PSCell or occurs during the PSCell change procedure. The source PSCell is a source PSCell of the latest PSCell change. The target PSCell is a target PSCell of the latest PSCell change. The measurement report received from the UE is received through the SCG failure information received by the MN from the UE.

The source SN can further decide whether the failure is caused by the unreasonable configuration of CPC candidate cells or by the unreasonable configuration of CPC execution condition. If the suitable cell is not in the CPC candidate cells configured to the UE, the failure is caused by the unreasonable configuration of CPC candidate cells. If the suitable cell is not in the list of the CPC candidate cells recommended by the source SN that triggers the PSCell change, the problem is caused by the source SN that triggers the PSCell change. If the suitable cell is in the list of the CPC candidate cells recommended by the source SN that triggers the PSCell change, but not in the list of the candidate PSCells selected by the target SN or the candidate target SN, the failure is caused by the target SN or the candidate target SN. For the trigger of the PSCell change to the wrong PSCell, the source SN can further decide whether the failure is caused by the unreasonable configuration of the candidate cell. The source SN can decide whether the failure is caused by the inappropriate maximum number of the prepared PSCells, and/or the inappropriate configuration of the estimated arrival probability.

For the failure caused by the target SN or the candidate target SN, the present disclosure proposes two approaches for indicating the failure to the target SN or the candidate target SN:

A first approach: the MN decides that whether the target SN or the candidate target SN leads to a problem, and the specific approach is described in step 302. The MN transmits indication or report information on the SCG failure to the target SN or the candidate target SN. The message includes a list of candidate PSCells recommended by the MN or the source SN, indication information on whether a PSCell is selected by the target SN or the candidate target SN in the list of the candidate PSCells recommended by the MN or the source SN, indication information on whether is a PSCell is not selected by the target SN or the candidate target SN in the list of the candidate PSCells recommended by the MN or the source SN, the maximum number of the prepared PSCells, a list of candidate PSCells selected by the target SN or the candidate target SN, a cell identity of the suitable PSCell, SCG failure information, a cell identity of the source PSCell, a cell identity of the target PSCell, a cell identity of the failed PSCell, a cell identity of the suitable PSCell which is not selected by the target SN or the candidate target SN, and/or indication information that the selected candidate PSCell is unsuitable. The SCG failure information is SCG failure information received from the UE. Each of the candidate PSCells includes a cell identity, which may be a global cell identity, and the global cell identity may further include a Tracking Area Code (TAC).

A second approach: the MN transmits the indication or report information on the SCG failure to the source SN, and the source SN further decides the type of the failure. If the source SN decides that the problem is caused by the target SN or the candidate target SN, the source SN transmits a message to the MN. The message transmitted by the source SN to the MN includes a MN UE Access Protocol (AP) identity, a SN UE AP ID, a list of candidate PSCells recommended by the source SN, indication information on whether a PSCell is selected by the target SN or the candidate target SN in the list of the candidate PSCells recommended by the source SN, indication information on whether a PSCell is not selected by the target SN or the candidate target SN in the list of the candidate PSCells recommended by the source SN, and the maximum number of the prepared PSCells, a list of candidate PSCells selected by the target SN or the candidate target SN, a cell identity of a suitable PSCell, SCG failure information, a cell identity of a source PSCell, a cell identity of a target PSCell, a cell identity of a failed PSCell, a cell identity of a suitable PSCell which is not selected by the target SN or the candidate target SN, and/or indication information that the selected candidate PSCell is unsuitable. Each of candidate PSCells contains a cell identity, which may be a global cell identity. The global cell identity may further include a Tracking Area Code (TAC). The source SN can transmit the above information to the MN through a SCG failure transfer message or other message. The MN transmits a message to the target SN or the candidate target SN, and the message includes the same information as those described in the first approach, which will not be repeated here.

The source SN can also decide whether the failure is caused by an estimated arrival probability which is set improperly, for example, the estimated arrival probability transmitted by the source SN to the candidate target SN via the MN is set too low, and the suitable cell is in the candidate SNs. In such a case, the source SN is the node that leads to the failure. The source SN can also decide whether the failure is caused by the improper setting of the maximum number of the prepared PSCells. For example, the maximum number of the prepared PSCells sent by the source SN via the MN to the candidate target SN is too low, resulting in that the target SN or the candidate SN does not select the suitable cell as the selected candidate cell, but the suitable cell is in the candidate SN. In this case, the source SN is the node that leads to the failure.

The CPC is optimized reasonably by the node (the source SN, the target SN or the candidate target SN, or the MN) which leads to the failure.

The CPC is taken as an example for the above description of trigger of the PSCell change to the wrong PSCell, and such a description is also applicable to the CPA procedure.

As such, the first method for supporting self-configuration and self-optimization proposed in the present disclosure has been described, and the method can support robustness of PSCell change in the enhanced mobility procedure, correctly identify the causes of failure, so as to make reasonable optimization, reduce occurrence of failure, ensure service continuity, and reduce labor cost of operators.

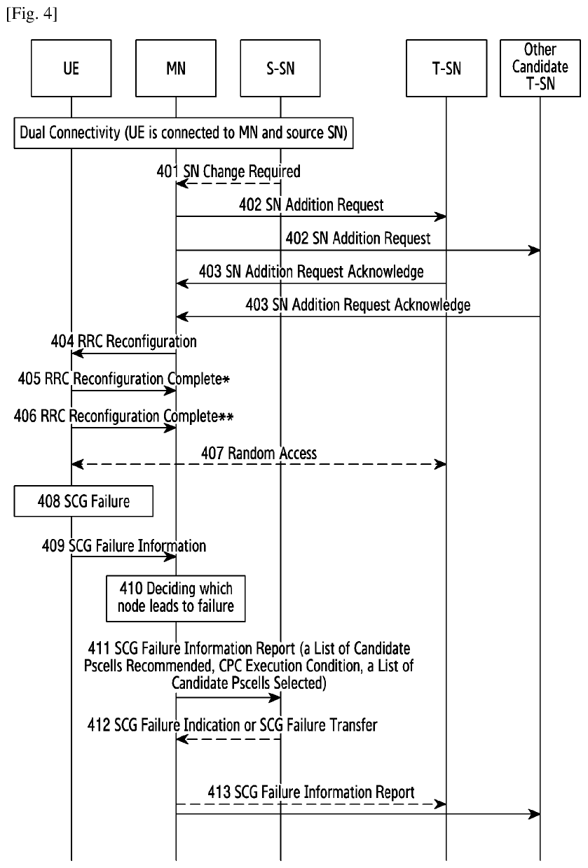

FIG. 4 illustrates an embodiment of the first method supporting self-configuration and self-optimization proposed in the present disclosure.

Referring to FIG. 4, the method comprises the following steps:

The UE is in a dual connectivity state, in which the UE is connected to both the MN and the source SN (S-SN) at the same time.

At step 401, the S-SN transmits a SN change required message to the MN. The message contains a candidate target node identity. The message may further include a list of candidate PSCells suggested by the source SN, CPC execution condition(s), and the maximum number of the prepared PSCells. For the CPC procedure triggered by the MN, this step does not need to be performed. Each of candidate PSCells contains a cell identity, which may be a global cell identity. The global cell identity may further include a Tracking Area Code (TAC). There are one or more execution conditions for each of candidate PSCell cells.

The MN stores information on the CPC procedure triggered by the S-SN.

At step 402, the MN transmits a SN addition request message to one or more target SNs. The MN stores the information on the CPC procedure triggered by the MN or the S-SN.

At step 403, the target SN or other candidate target SN transmits a SN addition request acknowledge message to the MN.

At step 404, the MN transmits a radio resource control (RRC) reconfiguration message to the UE. The message contains CPC configuration.

At step 405, the UE stores the CPC configuration and transmits a RRC reconfiguration complete message to the MN. The RRC reconfiguration complete message is the RRC reconfiguration complete*.

The UE starts to evaluate the execution condition.

At step 406, if the execution condition for a candidate PSCell is fulfilled, the UE applies a RRC reconfiguration message corresponding to the selected candidate PSCell. The UE transmits the RRC reconfiguration complete message to the MN. The RRC reconfiguration complete message is the RRC reconfiguration complete**. The message contains information on the selected PSCell.

At step 407, the UE performs a random access procedure to the target SN and synchronises to the target SN.

When the UE performs the CPC procedure to the target SN, a failure may occur. In the case of the failure of the CPC execution, and step 407 fails or does not need to be executed.

At step 408, a SCG failure occurs. The SCG failure may be a failure occurring when the UE performs the CPC to the target SN or a failure occurring after the procedure of step 407 is completed. The UE stores information on the failure. The information on the failure is the information of the secondary cell group failure described at step 301, which will not be repeated here.

At step 409, the UE transmits the SCG failure information to the MN. The SCG failure information contains the same information as those described at step 301, which is not repeated here. The UE may transmit the SCG failure information at step 301 to the MN through the existing SCG failure information message or other RRC messages.

At step 410, the MN decides which node causes the failure. The MN uses the same decision method as that at step 302, and will not be described here. The MN can further decide the type of failure, and the specific decision method is the same as that at step 302, which will not be repeated here.

If the failure is caused by the MN, the procedure ends, and the subsequent steps do not need to be performed.

For the problem caused by the source SN, step 411 is performed.

For the problem caused by the target SN or the candidate target SN, if the PSCell change is triggered by the MN, step 413 is directly performed. For the problem caused by the target SN or the candidate target SN, if the PSCell change is triggered by the source SN, in the case of the first approach of the present disclosure (the first approach at step 303), step 413 is directly performed; in the case of the second approach of the present disclosure (the second approach at step 303), the step 411, step 412 and step 413 are performed.

At step 411, the MN transmits the SCG failure information report message to the source SN. The message contains the same information as those transmitted by the MN to the source SN at step 303, which will not be repeated here. The message transmitted by the MN to the source SN may be an existing SCG failure information report or other message. If the type of the failure is decided by the source SN, the source SN uses the same decision method as that described at step 303.

If the suitable PSCell is recommended by the source SN, and the target SN or the candidate target SN does not select the suitable PSCell as the candidate PSCell, then step 412 is executed.

At step 412, the source SN transmits a SCG failure indication or a SCG failure transfer message to the MN, and the message contains the same information as that transmitted by the source SN to the MN at step 303, which will not be repeated here. The source SN may transmit the information described at step 303 to the MN through the existing SCG failure transfer message or other message.

At step 413, the MN transmits a SCG failure information report to the target SN or other candidate target SN. The SCG failure information report includes the same information as those transmitted by the MN to the target SN or other candidate target SN at step 303, which will not be repeated here. The MN can transmit the SCG failure information to the target SN or other candidate target SN through the the SCG failure information report or other message.

So far, the embodiment of the first method for supporting self-configuration and self-optimization proposed in the present disclosure has been described, and such a method can support robustness of the PSCell change in the enhanced mobility procedure, correctly identify the causes of the failure, so as to make reasonable optimization, reduce the occurrence of failure, ensure service continuity, and reduce the labor cost of operators

For the CPC procedure, embodiments of the present disclosure find the following technical problems:

A first problem: an SN triggers a CPC procedure through a Signalling Radio Bearer 3 (SRB3) without an involvement of an MN, and the MN also triggers a CPC procedure from a source SN to a target SN. In this scenario, after the UE successfully performs the CPC configured by the SN, the UE will release the CPC procedure configured by the MN. The UE transmits a RRC reconfiguration complete message to a new PSCell of the SN. The resources of candidate PSCell configured by the MN are still reserved, and not released in time, resulting in waste of radio resources.

A second problem: the SN triggers the CPC procedure through the Signaling Radio Bearer 3 (SRB3) without involvement of the MN, and the MN also triggers the CPC procedure from the source SN to the target SN. If the UE fails in the process of performing the CPC configured by the SN or the UE fails after successfully performing the CPC configured by the SN, the UE transmits the SCG failure information to the MN. The MN does not know that the CPC procedure has been triggered by the SN, and the MN does not have a list of the candidate PSCells for the CPC and the CPC execution condition(s) configured by the SN. If the MN decides which node causes the failure or the type of the failure according to the list of the candidate PSCells and the CPC execution condition(s) for the CPC procedure triggered by the MN, it may lead to errors in the decision, and thus not only a goal of network self-optimization cannot be achieved, but also negative effects may be brought to the network self-optimization.

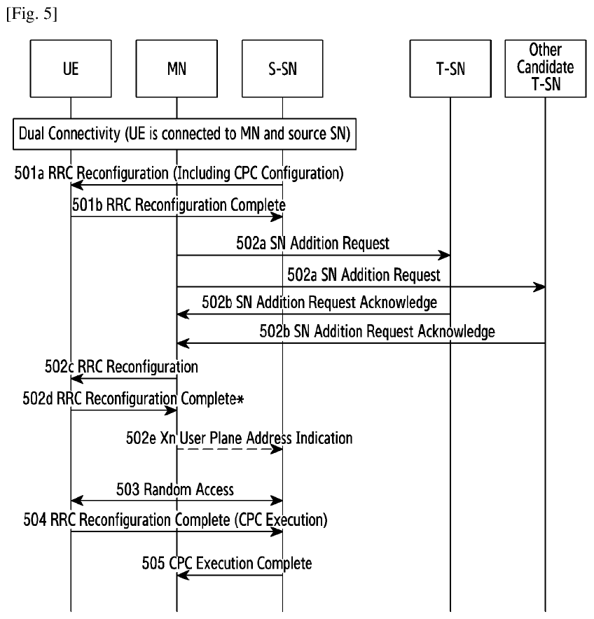

FIG. 5 illustrates the second method supporting self-configuration and self-optimization proposed in the present disclosure.

Referring to FIG. 5, the present disclosure may solve the first problem. The method comprises the following steps.

The UE may be in a dual connectivity state, in which the UE is connected to both the MN and the SN at the same time. For the inter-SN CPC procedure initiated by the MN, the SN is also the source SN (S-SN).

According to an embodiment, at step 501a, the SN may transmit a SN RRC reconfiguration message to the UE. The SN may transmit the message (or, SN RRC reconfiguration message) to the UE through the SRB3. The message includes CPC configuration.

At step 501b, the UE may start to evaluate the CPC execution condition(s) for one or more candidate PSCells. The UE may maintain a connection with the source PSCell. The UE transmits a RRC reconfiguration complete message to the SN. The UE may transmit the message to the SN through the SRB3.

At step 502a, the MN may transmit a SN addition request message to one or more candidate target SNs. The MN may store information that the MN triggered the CPC procedure.

At step 502b, the target SN or other candidate target SN may transmit a SN addition request acknowledge message to the MN.

According to an embodiment, at step 502c, the MN may transmit a RRC reconfiguration message to the UE. The message includes the CPC configuration.

According to an embodiment, at step 502d, the UE may store the CPC configuration and transmit a RRC reconfiguration complete message to the MN. The RRC reconfiguration complete message is a RRC reconfiguration complete*.

The UE may start to evaluate the CPC execution condition(s) for one or more candidate PSCells configured by the MN.

At step 502e, the MN may transmit an Xn user plane address indication message to the source SN.

According to an embodiment, at step 503, when the execution condition(s) for at least one candidate PSCell configured by the SN is fulfilled, the UE may apply the stored configuration corresponding to the selected candidate PSCell, and the UE may synchronize to the candidate PSCell.

According to an embodiment, the UE may release other CPC configurations including the CPC configuration configured by the MN and/or other CPC configurations configured by the SN. At step 504, the UE may transmit a RRC reconfiguration complete message to the SN. The UE may transmit the message to the SN through the SRB3. The message may include indication information that the MN has configured the CPC. With the indication information indicating that the MN has configured the CPC, the SN can know that the MN has also configured the CPC procedure, so that the SN can request the MN to release the resources for one or more candidate PSCells prepared by the MN in time.

At step 505, the SN may transmit, to the MN, information that the CPC using SRB3 has been executed by the UE. The information may include a UE identity (ID), and the UE identity is MN UE Xn AP ID and/or SN UE Xn AP ID of the UE. The information may include a new PSCell identity. The information may further include indication information on CPC cancellation. The SN can transmit the information of this step to the MN when it knows that the MN has triggered the CPC procedure, or the SN can always transmit the information to the MN. Upon receiving an Xn user plane indication message (for example, the message at step 502e), the SN can know that the MN has triggered the CPC procedure, and thus transmit the information of this step to the MN. The SN can know that the MN has triggered the CPC procedure in other ways. For example, after receiving the RRC reconfiguration complete message of step 502d, the MN may transmit the indication information that the CPC is triggered to the source SN if step 502e does not need to be performed, so that the SN knows that the MN also triggered the CPC procedure. The SN can also know that the CPC procedure is triggered by the MN through the UE. Correspondingly to the method, the RRC reconfiguration complete message at step 504 may include the information that the CPC procedure is configured by the MN.

The MN may transmit a SN release request message to one or more candidate target SNs, for requesting to release the CPC.

So far, the embodiment of the second method supporting self-configuration and self-optimization proposed in the present disclosure has been described, and method can support the robustness of the PSCell change in the enhanced mobility procedure and release the reserved radio resources in time.

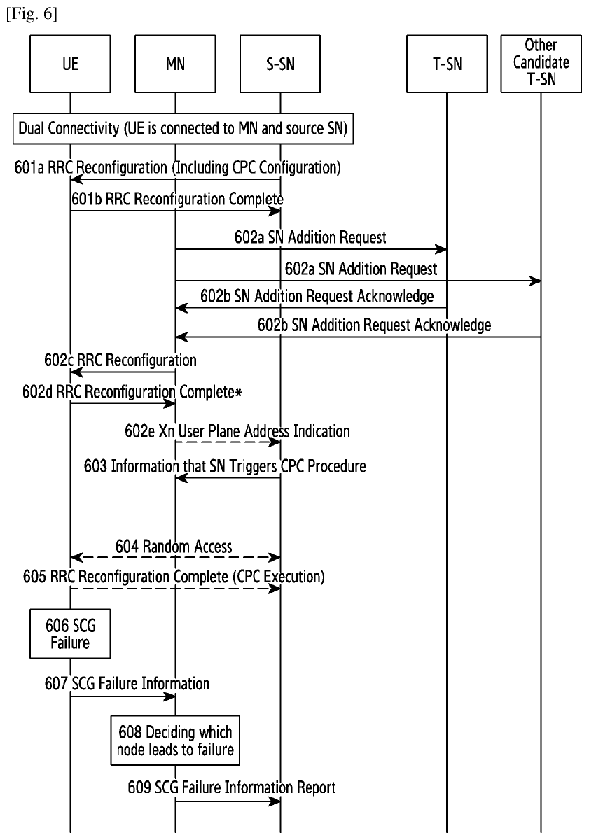

FIG. 6 illustrates the third method supporting self-configuration and self-optimization as proposed in the present disclosure.

Referring to FIG. 6, the present method can solve the second problem mentioned above. A detailed description of steps unrelated to the embodiment of present disclosure is omitted here. The method comprises the following steps.

The UE is in a dual connectivity state where the UE is connected to both the MN and the SN at the same time. For the inter-SN CPC procedure initiated by the MN, the SN is also the source SN (S-SN).

Steps 601a to 602e are the same as steps 501a to 502e, and the description thereof will not be repeated here.

At step 603, the SN transmits information that the SN triggered the CPC procedure to the MN. The message contains information that the SN triggered the CPC procedure, a list of candidate PSCells, and/or CPC execution condition(s). Each of candidate PSCells contains a cell identity, which may be a global cell identity. The global cell identity may further include a Tracking Area Code (TAC). There are one or more execution conditions for each of candidate PSCell. The SN may transmit the information to the MN when the CPC procedure is configured, or the SN may transmit the information to the MN when it knows that the MN has also triggered the CPC procedure. Upon receiving a message indicating the Xn user plane address, SN knows that MN has also triggered the CPC procedure. If the Xn user plane address indication message is not needed (for example, early data forwarding is not needed), the MN can transmit the information that the MN triggered the CPC procedure to the SN through other message. For example, after receiving the RRC reconfiguration complete message of step 602d, the MN transmits the information that the MN triggered the CPC procedure to the SN, so that the SN knows that the MN has triggered the CPC procedure. The SN can know that the MN triggered the CPC procedure in other ways, so as to transmit the information of step 603 without affecting the main content of the present disclosure.

The SN in this step is also the source SN from which MN triggers the SN change.

At step 604, the execution condition(s) for at least one of candidate PSCell configured by the SN is fulfilled, and the UE applies the stored configuration corresponding to the selected candidate PSCell, and the UE synchronises to the candidate PSCell.

The UE releases other CPC configurations, including the CPC configuration configured by the MN and/or other CPC configuration configured by the SN.

The SN in this step is also the source SN from which MN triggers the SN change.

At step 605, the UE transmits a RRC reconfiguration complete message to the SN. The UE transmits the message to the SN through SRB3.

The SN in this step is also the source SN from which MN triggers the SN change.

At step 606, the SCG failure occurs. The SCG failure can occur after success of the CPC to the SN, or during the CPC execution to the SN, that is, the CPC execution to the SN fails. In the case that the CPC execution to the SN fails, the random access at step 604 may fail or need not be performed, and step 605 need not be performed.

UE stores the information on the failure. The information on the failure includes one or more of the following information:
A list of candidate PSCells configured by the SN. Each of candidate PSCells includes a cell identity, which may be a global cell identity, and the global cell identity may further include a Tracking Area Code (TAC);
One or more CPC execution conditions configured by the SN. There are one or more execution conditions for each of candidate PSCell;
Indication information that the CPC configured by the SN failed;
Information which execution condition is fulfilled;
Information which execution condition is fulfilled first;
A time between two execution conditions being fulfilled, for example, the time can be a time duration between the two CPC execution conditions being fulfilled;
A cell identity of the PSCell where the failure occurs;
A cell identity of the source PSCell;
A time from the CPC execution to the failure;
A Time from receiving CPC configuration to the CPC execution. A time from receiving the CPC configuration of the SN to CPC execution to a new PSCell of the SN, and/or a time from receiving the CPC configuration of the MN to CPC execution to a candidate PSCell configured by the MN;
Indication information that the MN has configured the CPC procedure;
A list of candidate PSCells configured by the MN. Each of candidate PSCells includes a cell identity, which may be a global cell identity, and the global cell identity may further include a Tracking Area Code (TAC);
CPC execution condition(s) configured by the MN. There are one or more execution conditions for each of candidate PSCells;
Indication Information on the failure of the CPC configured by the MN.

The failure information is SCG failure information.

At step 607, the UE transmits the SCG failure information to the MN. The SCG failure information includes one or more of the failure information stored at step 606.

At step 608, the MN decides which node leads to the failure. If the MN receives the indication information that the CPC configured by the SN fails, the MN directly transmits a SCG failure report message to the SN. The message contains the SCG failure information received from the UE. The MN can also decide which node leads to the failure according to the method at step 302. The MN can know, from the SN through step 603, that the SN triggered the CPC procedure, a list of CPC candidate PSCells, and/or the CPC execution condition(s). The MN can also know, from the UE through step 607, that the SN triggered the CPC procedure, a list of CPC candidate PSCells configured by the SN, the CPC execution condition(s) configured by the SN, and/or CPC failure of the SN. The CPC failure of SN includes a CPC execution to the SN failure or the SCG failure occurring after a successful CPC execution to the SN. Each of candidate PSCells contains a cell identity, which may be a global cell identity. The global cell identity can further include a Tracking Area Code (TAC). There are one or more execution conditions for each of candidate PSCell.

If MN decides that the failure is caused by the SN, MN cancels the CPC procedure to other candidate SNs prepared by the MN, the CPC procedure is a CPC procedure to the target candidate SN, which is triggered and prepared by the MN. As another implementation of the present disclosure, the MN can reserve the CPC procedure prepared by the MN.

At step 609, the MN transmits the SCG failure information report to the SN. The message contains one or more of the following information elements:
A cell identity of a source PSCell;
A cell identity of a target PSCell, the target PSCell is at least one of candidate PSCells configured by the SN, and the CPC execution for the UE to the PSCell fails or the UE fails in the PSCell after successful execution;
A cell identity of a suitable PSCell;
SCG failure information received from the UE;
A list of candidate PSCells configured by the SN; each of candidate PSCells includes a cell identity, which may be a global cell identity, and the global cell identity may further include a Tracking Area Code (TAC);
CPC execution condition(s) configured by the SN; there are one or more execution conditions for each of candidate PSCell.

The SN decides a type of the failure after receiving the message from the MN, such as a too early PSCell change, a too late PSCell change or trigger of a PSCell change to a wrong PSCell. The specific decision approach is the same as that described at step 303, and the description thereof will not be repeated here.

The SN can further decide whether the failure is caused by unreasonable configuration of CPC candidate cells or unreasonable configuration of CPC execution condition(s). If the suitable cell is not in the CPC candidate cells configured to the UE, the failure is caused by the unreasonable configuration of CPC candidate cells.

The SN optimizes the CPC reasonably.

It should be noted that, in the present method, except that the SNs described at step 602a and step 602b are the target SN or other candidate target SN, the SNs in other steps are the source SN from which the MN triggered the CPC procedure.

So far, the third method supporting self-configuration and self-optimization proposed in the present disclosure has been described, and such a method can support an robustness of the PSCell change in the enhanced mobility procedure and correctly identify the cause of the failure, so as to make a reasonable optimization, reduce occurrence of the failure, ensure service continuity, and reduce labor cost of operators.

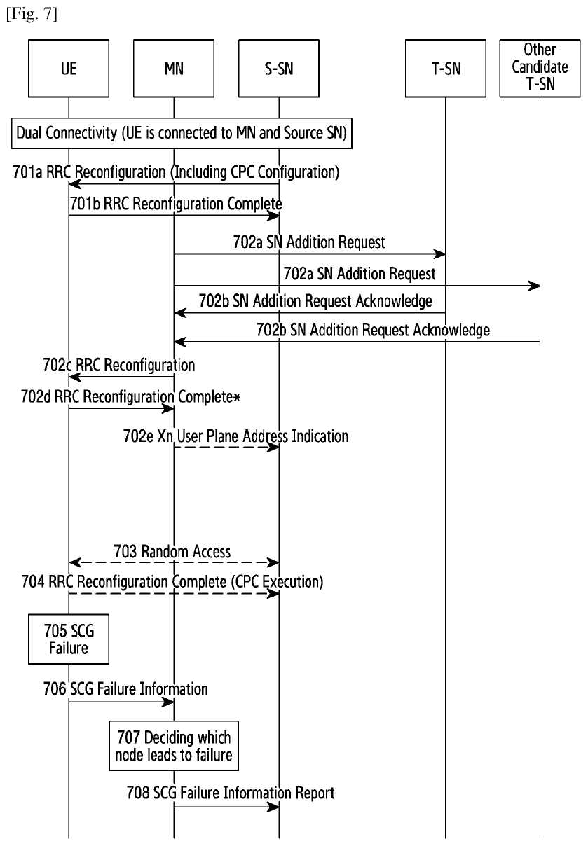

FIG. 7 illustrates the fourth method supporting self-configuration and self-optimization as proposed in the present disclosure.

Referring to FIG. 7, the present method can solve the second problem mentioned above. Detailed description of steps unrelated to the embodiment of the present invention is omitted here. The method comprises the following steps:

According to an embodiment, the UE is in a dual connectivity state where the UE is connected to both the MN and the SN at the same time. For the inter-SN CPC procedure initiated by the MN, the SN is also the source SN (S-SN).

Steps 701a to 702e are the same as the steps 501a to 502e, and the description thereof will not be repeated here.

At step 703, in the case that execution condition(s) of at least one candidate PSCell configured by the SN is fulfilled, and the UE applies the stored configuration corresponding to the selected candidate PSCell and synchronises to the candidate PSCell.

The UE releases other CPC configurations, including the CPC configuration configured by the MN and/or the CPC configuration of other candidate PSCells configured by the SN.

The SN in this step is also the source SN from which the MN triggered the SN change.

At step 704, the UE transmits a RRC reconfiguration complete message to the SN. The UE transmits the message to the SN through the SRB3.

The SN in this step is also the source SN from which the MN triggered the SN change.

At step 705, SCG failure occurs. The SCG failure can occur after success of the CPC to the SN or during the CPC execution to the SN, that is, the CPC execution of the candidate PSCell to the SN fails. In the case that the CPC execution to the SN fails, the random access at step 703 may be failed or need not be performed, and step 704 need not be executed.

The UE stores the failure information, and the specific stored failure information can be one or more information included in the SCG failure information at step 706.

At step 706, the UE transmits the SCG failure information to the MN. The SCG [240] failure information includes one or more of the following information:
A list of candidate PSCells configured by the SN. Each of candidate PSCells contains a cell identity, which may be a global cell identity, and the global cell identity can further include a Tracking Area Code (TAC);
One or more CPC execution conditions configured by the SN. There are one or more execution conditions for each of candidate PSCells;
Indication information that the CPC configured by the SN failed;
Information which execution condition is fulfilled;
Information which execution condition is fulfilled first;
A time between two execution conditions being fulfilled, for example, the time can be a time duration between the two CPC execution conditions being fulfilled;
A cell identity of a PSCell where the failure occurs;
A cell identity of a source PSCell;
A time from the CPC execution to the failure;
A time from receiving the CPC configuration to the CPC execution. A time from receiving the CPC configuration of the SN to CPC execution to a new PSCell of the SN, and/or a time from receiving the CPC configuration of the MN to the CPC execution to the candidate PSCell configured by the MN;
Indication information that the MN has configured the CPC procedure;
A list of candidate PSCells configured by the MN. Each of candidate PSCells contains a cell identity, which may be a global cell identity, and the global cell identity can further include a Tracking Area Code (TAC);
CPC execution condition(s) configured by the MN. There are one or more execution conditions for each of candidate PSCells;
Indication information that the CPC configured by the MN failed.

At step 707, the MN decides which node causes the failure. If the MN receives the indication information that the CPC configured by the SN failed, the MN directly transmits the SCG failure report message to the SN. The message contains the SCG failure information received from the UE. The MN can also decide which node causes the failure according to the method at step 302.

If the MN decides that the failure is caused by the SN, the MN cancels a CPC procedure to other candidate SN prepared by the MN, and the CPC procedure is a CPC procedure to a target candidate SN triggered and prepared by the MN. As another implementation of the present disclosure, the MN can reserve the CPC procedure prepared by the MN.

At step 708, the MN transmits the SCG failure information report to the SN. The message contains one or more of the following information elements:
A cell identity of a source PSCell;
A cell identity of a target PSCell; the target PSCell is at least one of the candidate PSCells configured by the source SN, and the CPC execution for the UE to the PSCell fails or the UE fails in the PSCell after a successful execution;
A cell identity of a suitable PSCell;
SCG failure information received from the UE;
A list of candidate PSCells configured by the SN; each of candidate PSCells includes a cell identity, which may be a global cell identity, and the global cell identity may further include a Tracking Area Code (TAC);
CPC execution condition(s) configured by the SN; there are one or more execution conditions for each of candidate PSCells.

The SN decides a type of the failure after receiving the message from the MN, such as a too early PSCell change, a too late PSCell change or trigger of a PSCell change to a wrong PSCell. The specific decision approach is the same as that described at step 303, and the description thereof it will not be repeated here.

The SN can further decide whether the failure is caused by unreasonable configuration of CPC candidate cells or an unreasonable configuration of CPC execution condition(s). If a suitable cell is not in the CPC candidate cells configured to the UE, the failure is caused by the unreasonable configuration of CPC candidate cells.

The SN optimizes the CPC reasonably.

It should be noted that, in the present method, except that the SNs described at step 702a and step 702b are the target SN or other candidate target SN, the SNs in other steps are the source SN from which the MN triggered the CPC procedure.

So far, the fourth method supporting self-configuration and self-optimization in the present disclosure has been described, and the fourth method can support robustness of the PSCell change in the enhanced mobility procedure, correctly identify a cause of the failure, so as to make reasonable optimization, reduce occurrence of the failure, ensure service continuity, and reduce labor cost of operators.

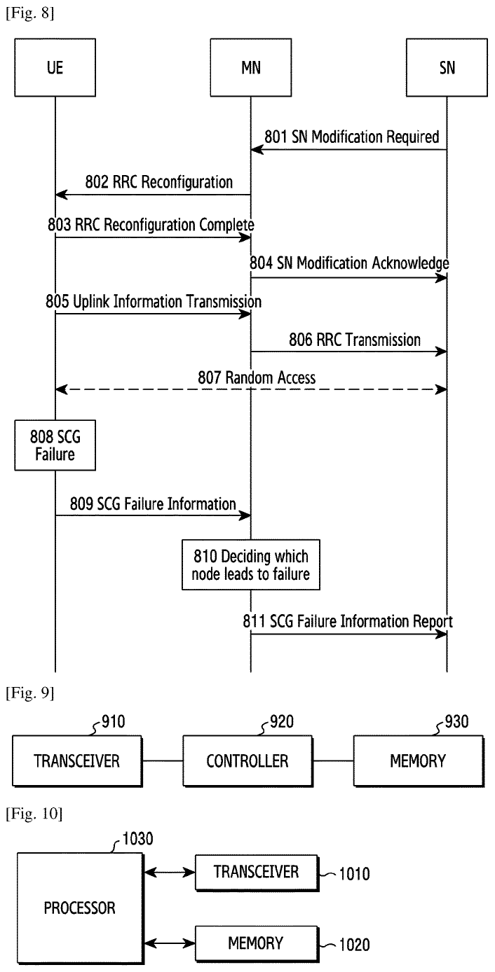

FIG. 8 illustrates an embodiment of a fifth method supporting self-configuration and self-optimization as proposed in the present disclosure.

Referring to FIG. 8, detailed description of steps unrelated to the embodiment is omitted here. The method comprises the following steps:

At step 801, the SN transmits a SN modification required message to the MN. The message includes a SN RRC reconfiguration message. The message contains a list of one or more candidate PSCells. The message further contains the CPC execution condition(s). There are one or more execution conditions for each of candidate PSCells.

At step 802, the MN transmits a RRC reconfiguration message to the UE. The MN forwards the SN RRC reconfiguration message to the UE.

At step 803, the UE transmits a RRC reconfiguration complete message to the MN. The RRC reconfiguration complete message includes a SN RRC reconfiguration complete message.

The UE starts to evaluate the CPC execution condition(s) for one or more candidate PSCells.

At step 804, the MN forwards the SN RRC reconfiguration complete message to the SN. The MN transmits the SN RRC reconfiguration complete message to the SN through a SN modification acknowledge message.

At Step 805, if at least one CPC candidate PSCell satisfies the corresponding CPC execution condition(s), the UE transmits an uplink information transmission message to the MN. The message includes a RRC reconfiguration complete message for the selected target PSCell. The uplink information transfer can also be referred to as an uplink information transfer multi-radio access technology dual connectivity (MRDC).

At step 806, the MN forwards the RRC reconfiguration complete message to the SN. The MN transmits the RRC reconfiguration complete message to the SN through RRC transfer.

At step 807, the UE synchronises to the selected candidate PSCell.

At step 808, the SCG fails. The SCG failure can occur after the CPC execution is successful or during the CPC execution, that is, the CPC execution to the selected candidate PSCell fails. In the case that the CPC execution to the selected candidate PSCell fails, the random access procedure at step 807 fails or does not need to be performed.

The UE stores failure information, and the specific stored failure information is one or more of the SCG failure information at step 809.

At step 809, the UE transmits the SCG failure information to the MN. The SCG failure information contains one or more of the following information:
Indication information that the CPC configured by the SN failed;
A list of candidate PSCells configured by the SN. The list includes a list of the latest candidate PSCells configured to the UE, or a list of candidate PSCells which are in the candidate PSCells configured to the UE but are not in a measurement results of the UE. Each of candidate PSCells includes a cell identity, which may be a global cell identity, and the global cell identity may further include a Tracking Area Code (TAC);
CPC execution condition(s) configured by the SN. There are one or more execution conditions for each of candidate PSCells;
Information which CPC execution condition is fulfilled;
A time from the CPC execution to the failure;
A time from the CPC configuration to the failure;
A time from the CPC configuration to the CPC execution;
Information which CPC execution condition is fulfilled first;
A Time between two events being fulfilled, for example, the events may be the above CPC execution conditions, and the time may be a time duration between the two events being fulfilled;
Measurement result of the UE. The measurement result includes measurement results for a serving PSCell and a neighboring PSCell. For the cell in the measurement result which is the candidate PSCell configured by the SN, the measurement result further includes indication information that the cell is the candidate PSCell. Corresponding to such an approach, the candidate PSCell which is in the candidate PSCells configured to the UE but is not in the measurement results of the UE is included in a list of candidate PSCells in the SCG failure information.

At step 810, the MN decides which node leads to the failure. If the MN receives indication information that the CPC configured by the SN failed, the MN directly transmits the SCG failure report message to the SN. The message contains the SCG failure information received from UE. The MN can also decide which node leads to the failure according to the method at step 302.

At step 811, the MN transmits the SCG failure information report to the SN. The message contains one or more of the following information elements:
A cell identity of a source PSCell;
A cell identity of a target PSCell; the target PSCell is one of the candidate PSCells configured by the source SN, and the CPC execution for the UE to the PSCell failed or the UE failed in the PSCell after a successful execution;
A cell identity of a suitable PSCell;
SCG failure information received from the UE;
A list of candidate PSCells configured by the SN; each of candidate PSCells contains a cell identity, which may be a global cell identity, and the global cell identity may further include a Tracking Area Code (TAC);
CPC execution condition(s) configured by the SN; there are one or more execution conditions for each of candidate PSCells.

The SN determines a type of the failure after receiving the message from the MN, such as a too early PSCell change, a too late PSCell change or trigger of a PSCell change to a wrong PSCell. The specific decision approach is the same as that described at step 303, and the description thereof will not be repeated here.

The SN can further determine whether the failure is caused by unreasonable configuration of CPC candidate cells or unreasonable configuration of CPC execution condition(s). If the suitable cell is not in the CPC candidate cells configured to the UE, the failure is caused by the unreasonable configuration of CPC candidate cells.

The SN optimizes the CPC reasonably.

So far, the embodiment of the fifth method supporting self-configuration and self-optimization as proposed in the present disclosure has been described, and the fifth method can support an robustness of the PSCell change in the enhanced mobility procedure, correctly identify a cause of the failure, so as to make reasonable optimization, reduce occurrence of the failures, ensure service continuity, and reduce labor cost of operators.

FIG. 9 is a block diagram of a node device in a network according to the present disclosure.

Referring to FIG. 9, the node device in the network can be used to implement the MN, the SN, the S-SN, the T-SN, other candidate T-SNs, etc. in the present disclosure. With reference to FIG. 9, the network device according to the present disclosure includes a transceiver 910, a controller 920 and a memory 930. The transceiver 910, the controller 920 and the memory 930 are configured to perform operations of the methods and/or embodiments of the present disclosure. Although the transceiver 910, the controller 920 and the memory 930 are illustrated as separate entities, they can be implemented as a single entity, such as a single chip. The transceiver 910, the controller 920 and the memory 930 may be electrically connected or coupled to each other. Transceiver 910 can transmit signals to other network devices and receive signals from other network entities, such as UE, MN, SN, S-SN, T-SN, other candidate T-SNs or core network nodes. The controller 920 may include one or more processing units, and may control network devices to perform operations and/or functions according to one of the above embodiments. The memory 930 may store instructions for implementing the operations and/or functions of one of the above embodiments.

According to an embodiment, a method performed by a user equipment (UE) in a wireless communication system is provided. The method comprises receiving, from a secondary node (SN), an SN radio resource control (RRC) message including a first conditional primary secondary cell group cell change (CPC) configuration for an intra-SN CPC, receiving, from a master node (MN), an MN RRC message including a second CPC configuration for an inter-SN CPC, in case that a candidate primary secondary cell group cell (PSCell) satisfies a corresponding CPC execution condition of the first CPC configuration, performing a synchronization to the candidate PSCell, removing the second CPC configuration and transmitting an RRC reconfiguration complete message on the candidate PSCell.

The method further comprises evaluating at least one CPC execution condition for at least one candidate PSCell included in the first CPC configuration for the intra-SN CPC and transmitting, to the SN via a signaling radio bearer 3 (SRB3), an RRC reconfiguration complete message as a response to the SN RRC message.

The method further comprises storing the second CPC configuration for the inter-SN CPC and evaluating at least one CPC execution condition for at least one candidate PSCell included in the second CPC configuration for the inter-SN CPC.

The method further comprises applying a configuration of the first CPC configuration corresponding to the candidate PSCell for the synchronization to the candidate PSCell.

According to an embodiment, a user equipment (UE) in a wireless communication system is provided. The UE comprises a transceiver and a controller coupled with the transceiver and configured to receive, from a secondary node (SN), an SN radio resource control (RRC) message including a first conditional primary secondary cell group cell change (CPC) configuration for an intra-SN CPC, receive, from a master node (MN), an MN RRC message including a second CPC configuration for an inter-SN CPC, in case that a candidate primary secondary cell group cell (PSCell) satisfies a corresponding CPC execution condition of the first CPC configuration, perform a synchronization to the candidate PSCell, remove the second CPC configuration and transmit an RRC reconfiguration complete message on the candidate PSCell.

The controller is further configured to evaluate at least one CPC execution condition for at least one candidate PSCell included in the first CPC configuration for the intra-SN CPC and transmit, to the SN via a signaling radio bearer 3 (SRB3), an RRC reconfiguration complete message as a response to the SN RRC message.

The controller is further configured to store the second CPC configuration for the inter-SN CPC and evaluate at least one CPC execution condition for at least one candidate PSCell included in the second CPC configuration for the inter-SN CPC.

The controller is further configured to apply a configuration of the first CPC configuration corresponding to the candidate PSCell for the synchronization to the candidate PSCell.

According to an embodiment, a method performed by a secondary node (SN) in a wireless communication system is provided. The method comprises transmitting, to a user equipment (UE), an SN radio resource control (RRC) message including a first conditional primary secondary cell group cell change (CPC) configuration for an intra-SN CPC and in case that a candidate primary secondary cell group cell (PSCell) satisfies a corresponding CPC execution condition of the first CPC configuration, receiving, from the UE, an RRC reconfiguration complete message on the candidate PSCell. The candidate PSCell is based on the first CPC configuration for the intra-SN CPC and is not based on a second CPC configuration for an inter-SN CPC.

The method further comprises receiving, from the UE, an RRC reconfiguration complete message as a response to the SN RRC message.

The SN radio RRC message is transmitted via signaling radio bearer 3 (SRB3), and
wherein the RRC reconfiguration complete message is received via SRB3.

A configuration of the first CPC configuration corresponding to the candidate PSCell is applied for the candidate PSCell.

According to an embodiment, a secondary node (SN) in a wireless communication system is provided. The SN comprises a transceiver and a controller coupled with the transceiver and configured to transmit, to a user equipment (UE), an SN radio resource control (RRC) message including a first conditional primary secondary cell group cell change (CPC) configuration for an intra-SN CPC and in case that a candidate primary secondary cell group cell (PSCell) satisfies a corresponding CPC execution condition of the first CPC configuration, receive, from the UE, an RRC reconfiguration complete message on the candidate PSCell. The candidate PSCell is based on the first CPC configuration for the intra-SN CPC and is not based on a second CPC configuration for an inter-SN CPC.

The controller is further configured to receive, from the UE, an RRC reconfiguration complete message as a response to the SN RRC message.

The SN radio RRC message is transmitted via signaling radio bearer 3 (SRB3), and the RRC reconfiguration complete message is received via SRB3.

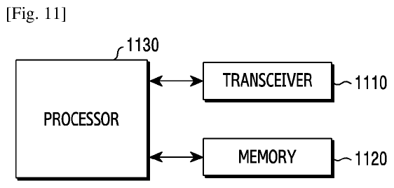

FIG. 10 illustrates a structure of a UE according to an embodiment of the disclosure. Referring to FIG. 10, the UE according to an embodiment may include a transceiver [323] 1010, a memory 1020, and a processor 1030. The transceiver 1010, the memory 1020, and the processor 1030 of the UE may operate according to a communication method of the UE described above. However, the components of the UE are not limited thereto. For example, the UE may include more or fewer components than those described above. In addition, the processor 1030, the transceiver 1010, and the memory 1020 may be implemented as a single chip. Also, the processor 1030 may include at least one processor. Furthermore, the UE of FIG. 11 corresponds to the UE 101 of the FIG. 1, respectively.

The transceiver 1010 collectively refers to a UE receiver and a UE transmitter, and may transmit/receive a signal to/from a base station or a network entity. The signal transmitted or received to or from the base station or a network entity may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor 1030, a signal through a wireless channel, and transmit a signal output from the processor 1030 through the wireless channel.

The memory 1020 may store a program and data required for operations of the UE. Also, the memory 1020 may store control information or data included in a signal obtained by the UE. The memory 1020 may be a storage medium, such as read-only memory (ROM), random access memory (RAM), a hard disk, a CD-ROM, and a DVD, or a combination of storage media.

The processor 1030 may control a series of processes such that the UE operates as described above. For example, the transceiver 1010 may receive a data signal including a control signal transmitted by the base station or the network entity, and the processor 1030 may determine a result of receiving the control signal and the data signal transmitted by the base station or the network entity.

FIG. 11 illustrates a structure of a base station according to an embodiment of the disclosure.

Referring to FIG. 11, the base station according to an embodiment may include a transceiver 1110, a memory 1120, and a processor 1130. The transceiver 1110, the memory 1120, and the processor 1130 of the base station may operate according to a communication method of the base station described above. However, the components of the base station are not limited thereto. For example, the base station may include more or fewer components than those described above. In addition, the processor 1130, the transceiver 1110, and the memory 1120 may be implemented as a single chip. Also, the processor 1130 may include at least one processor. Furthermore, the base station of FIG. 11 corresponds to base station (e.g., NG-RAN 202 of FIG. 2, or E-UTRAN 102 of FIG. 1).

The transceiver 1110 collectively refers to a base station receiver and a base station transmitter, and may transmit/receive a signal to/from a terminal (UE) or a network entity. The signal transmitted or received to or from the terminal or a network entity may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the processor 1130, a signal through a wireless channel, and transmit a signal output from the processor 1130 through the wireless channel.

The memory 1120 may store a program and data required for operations of the base station. Also, the memory 1120 may store control information or data included in a signal obtained by the base station. The memory 1120 may be a storage medium, such as read-only memory (ROM), random access memory (RAM), a hard disk, a CD-ROM, and a DVD, or a combination of storage media.

The processor 1130 may control a series of processes such that the base station operates as described above. For example, the transceiver 1110 may receive a data signal including a control signal transmitted by the terminal, and the processor 1130 may determine a result of receiving the control signal and the data signal transmitted by the terminal.

Those skilled in the art will understand that the above illustrative embodiments are described herein and are not intended to be limiting. It should be understood that any two or more of the embodiments disclosed herein can be combined in any combination. In addition, other embodiments can be utilized and other changes can be made without departing from the spirit and scope of the subject matter presented herein. It will be readily understood that aspects of the present disclosure as generally described herein and illustrated in the drawings can be arranged, replaced, combined, separated and designed in various different configurations, all of which are contemplated herein.

Those skilled in the art will understand that various illustrative logical blocks, modules, circuits, and steps described in the present application can be implemented as hardware, software, or combinations of both. To clearly illustrate such interchangeability between hardware and software, various illustrative components, blocks, modules, circuits, and steps are generally described above in the form of their functional sets. Whether such a function set is implemented as hardware or software depends on the specific application and the design constraints imposed on the overall system. Technicians can implement the described set of functions in different ways for each specific application, but such design decisions should not be interpreted as causing a departure from the scope of the present application.

The various illustrative logic blocks, modules, and circuits described in the present application can be implemented with a general purpose processor, a Digital Signal Processor (DSP), an application specific integrated circuit (ASIC), a Field Programmable Gate Array (FPGA) or other programmable logic devices, discrete gate or transistor logic, discrete hardware components, or any combination thereof designed to perform the functions described herein. The general-purpose processor may be a microprocessor, but in an alternative, the processor may be any conventional processor, controller, microcontroller, or state machine. The processor can also be implemented as a combination of computing devices, such as a combination of a DSP and a microprocessor, a plurality of microprocessors, one or more microprocessors cooperating with a DSP core, or any other such configuration.

The steps of the method or algorithm described in the present application can be directly embodied in hardware, in a software module executed by a processor, or in a combination of the two. The software modules may reside in RAM memory, flash memory, ROM memory, EPROM memory, EEPROM memory, registers, hard disks, removable disks, or any other form of storage media known in the art. An exemplary storage medium is coupled to the processor so that the processor can read and write information from/to the storage medium. In an alternative, the storage medium may be integrated into the processor. The processor and the storage medium may reside in the ASIC. The ASIC may reside in the user terminal. In an alternative, the processor and the storage medium may reside as discrete components in the user terminal.

In one or more exemplary designs, the functions can be implemented in hardware, software, firmware, or any combination thereof. If implemented in software, each function can be stored on or transferred by a computer-readable medium as one or more instructions or codes. Computer readable media include both computer storage media and communication media, the latter including any media that facilitates the transfer of computer programs from one place to another. Storage media can be any available media that can be accessed by general-purpose or special-purpose computers.

The above descriptions are only exemplary implementations of the present application, and are not intended to limit the protection scope of the present application, which is determined by the appended claims.

1. A method performed by a user equipment (UE) in a wireless communication system, the method comprising:
receiving, from a secondary node (SN), an SN radio resource control (RRC) message including a first conditional primary secondary cell group cell change (CPC) configuration for an intra-SN CPC;
receiving, from a master node (MN), an MN RRC message including a second CPC configuration for an inter-SN CPC;
in case that a candidate primary secondary cell group cell (PSCell) satisfies a corresponding CPC execution condition of the first CPC configuration, performing a synchronization to the candidate PSCell;
removing the second CPC configuration; and
transmitting an RRC reconfiguration complete message on the candidate PSCell.

2. The method of claim 1, further comprising:
evaluating at least one CPC execution condition for at least one candidate PSCell included in the first CPC configuration for the intra-SN CPC; and
transmitting, to the SN via a signaling radio bearer 3 (SRB3), an RRC reconfiguration complete message as a response to the SN RRC message.

3. The method of claim 1, further comprising:
storing the second CPC configuration for the inter-SN CPC; and
evaluating at least one CPC execution condition for at least one candidate PSCell included in the second CPC configuration for the inter-SN CPC.

4. The method of claim 1, further comprising:
applying a configuration of the first CPC configuration corresponding to the candidate PSCell for the synchronization to the candidate PSCell.

5. A user equipment (UE) in a wireless communication system, the UE comprising:
a transceiver; and
a controller coupled with the transceiver and configured to:
receive, from a secondary node (SN), an SN radio resource control (RRC) message including a first conditional primary secondary cell group cell change (CPC) configuration for an intra-SN CPC;
receive, from a master node (MN), an MN RRC message including a second CPC configuration for an inter-SN CPC;
in case that a candidate primary secondary cell group cell (PSCell) satisfies a corresponding CPC execution condition of the first CPC configuration, perform a synchronization to the candidate PSCell;
remove the second CPC configuration; and
transmit an RRC reconfiguration complete message on the candidate PSCell.

6. The UE of claim 5, wherein the controller is further configured to:
evaluate at least one CPC execution condition for at least one candidate PSCell included in the first CPC configuration for the intra-SN CPC; and
transmit, to the SN via a signaling radio bearer 3 (SRB3), an RRC reconfiguration complete message as a response to the SN RRC message.

7. The UE of claim 5, wherein the controller is further configured to:
store the second CPC configuration for the inter-SN CPC; and
evaluate at least one CPC execution condition for at least one candidate PSCell included in the second CPC configuration for the inter-SN CPC.

8. The UE of claim 5, wherein the controller is further configured to:
apply a configuration of the first CPC configuration corresponding to the candidate PSCell for the synchronization to the candidate PSCell.

9. A method performed by a secondary node (SN) in a wireless communication system, the method comprising:
transmitting, to a user equipment (UE), an SN radio resource control (RRC) message including a first conditional primary secondary cell group cell change (CPC) configuration for an intra-SN CPC; and
in case that a candidate primary secondary cell group cell (PSCell) satisfies a corresponding CPC execution condition of the first CPC configuration, receiving, from the UE, an RRC reconfiguration complete message on the candidate PSCell,
wherein the candidate PSCell is based on the first CPC configuration for the intra-SN CPC and is not based on a second CPC configuration for an inter-SN CPC.

10. The method of claim 9, further comprising:
receiving, from the UE, an RRC reconfiguration complete message as a response to the SN RRC message.

11. The method of claim 9, wherein the SN radio RRC message is transmitted via signaling radio bearer 3 (SRB3), and
wherein the RRC reconfiguration complete message is received via SRB3.

12. The method of claim 9, wherein a configuration of the first CPC configuration corresponding to the candidate PSCell is applied for the candidate PSCell.

13. A secondary node (SN) in a wireless communication system, the SN comprising:
a transceiver; and
a controller coupled with the transceiver and configured to:
transmit, to a user equipment (UE), an SN radio resource control (RRC) message including a first conditional primary secondary cell group cell change (CPC) configuration for an intra-SN CPC; and
in case that a candidate primary secondary cell group cell (PSCell) satisfies a corresponding CPC execution condition of the first CPC configuration, receive, from the UE, an RRC reconfiguration complete message on the candidate PSCell,
wherein the candidate PSCell is based on the first CPC configuration for the intra-SN CPC and is not based on a second CPC configuration for an inter-SN CPC.

14. The SN of claim 13, wherein the controller is further configured to:
receive, from the UE, an RRC reconfiguration complete message as a response to the SN RRC message.

15. The SN of claim 13, wherein the SN radio RRC message is transmitted via signaling radio bearer 3 (SRB3), and
wherein the RRC reconfiguration complete message is received via SRB3.
